(19) United States
(12) Patent Application Publication
(10) Pub. No.: US 2010/0143550 A1
(43) Pub. Date: Jun. 10, 2010

(54) SAVOURY FOOD PRODUCT AND PROCESS TO PREPARE THE SAME

(75) Inventor: El-Sayed ABDEL-FATTAH, Zagazig Sharkia (EG)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., d/b/a UNILEVER, Englewood Cliffs, NJ (US)

(21) Appl. No.: 12/502,278

(22) Filed: Jul. 14, 2009

(30) Foreign Application Priority Data
Jul. 15, 2008 (EP) EP08160369

(51) Int. Cl. A23L 1/40; A23L 1/221; A23L 1/27; A23L 1/39

(52) U.S. Cl. 426/250; 426/540; 426/589; 426/615

(57) ABSTRACT

Savoury food product, comprising salt and/or fat, and further comprising a plant material comprising chlorophyll, and a food grade blue-coloured ingredient.

### FIELD OF THE INVENTION

The present invention relates to a savoury food product which comprises plant material comprising chlorophyll. The present invention further relates to a process to prepare said savoury food products.

### BACKGROUND OF THE INVENTION

Bouillon cubes and tablets are well-known products in both Western- and non-Western cuisine, and are used for e.g. preparing a bouillon or broth (e.g. by immersion in hot water). Similar formulations are used as a seasoning for e.g. seasoning soup, sauces, gravies, pasta or other foods. Also well known are concentrates for preparing soup or sauce (which need to be diluted with an aqueous liquid to form such soup or sauce). Bouillon cubes and tablets as well as soups or sauces are all types of savoury food products. Savoury food products may comprise one or more of salt, fat, possibly taste enhancers like monosodium glutamate, and one or more ingredients like herbs, spices, or other flavouring components, as well as additional ingredients like sugars, starches or derivatives thereof. Savoury food products may be solid, liquid or pasty. They may be dry concentrates which may contain at most 8% wt. of moisture. Such concentrates may have formats like cubes, tablets, powders and granules or agglomerates.

Many of such savoury food products like bouillon concentrates or seasonings contain herbs, vegetables or pieces thereof, e.g. for taste or visual reasons. Most of such herbs and vegetables have a green colour when fresh. When applied in conventional bouillon and seasoning cubes, tablets, powders or granules (which are more or less dry, i.e. have a total moisture content of below 8% wt., preferably below 5% wt., more preferably below 2% wt.) such herbs and vegetables are usually applied in a dried format. The originally green herbs and vegetables, when present in such dry seasoning or vegetable concentrate, have, however, a tendency to lose the green colour, and to fade to a yellowish colour over time upon storage, and still later to a slightly brownish colour. When a savoury food product such as e.g. bouillon, soup or sauce is in a liquid form, the green colour may change as well, which may give a grayish appearance to the bouillon, soup or sauce.

Needless to say, such is undesired from e.g. a visual point of view, as one doesn't see herbs, vegetables or pieces thereof easily anymore e.g. in the unwrapped bouillon cube (as the matrix of fat, salt, MSG, spices, meat- or vegetable extract is usually also yellowish or light brown), or when a powdered concentrate containing herbs or vegetables for a soup or sauce comes out of its package. This being undesired is especially the case for e.g. seasonings which contain a very high amount of green herbs, vegetables or pieces thereof (e.g. more than 10%, preferably more than 15% by weight, as then the fading of the yellow colour is the more visible the higher the amount of herbs, vegetables or pieces thereof. The fading may lead to a negative impression with the consumer of the quality of the concentrate, seasoning or herb preparation.

U.S. Pat. No. 6,586,033 describes a stable, acidified liquid or paste sauce emulsion containing extremely high solids and high salt content in conjunction with acidulants. The emulsion may comprise spice, herb, or dry seasoning mix to control the acidity.

DE3501305 describes a green drink comprising yellow to yellow-green vegetable juices or vegetable marrow or a mixture from them in an amount of from 25 to 100 wt %. It further comprises preferably 2-15 g/l blue algae.

### SUMMARY OF THE INVENTION

Hence, there is a need for a savoury food product, like a bouillon-, soup-, or sauce concentrate, seasonings, and herb preparations or a ready-to-eat bouillon, soup or sauce that comprises herbs and/or vegetables and/or pieces thereof, in a size which is visible to the naked eye, and which products, upon prolonged storage, have a good impression, of such herbs or vegetables or pieces thereof being of a green or greenish-colour, at least on the outside of such savoury food product. Prolonged storage in this context means storage for at least 1 months, preferably at least 3 months, more preferably at least 6 months.

It has now been found that such can be achieved (to at least some extent) by a savoury food product comprising, all percentages by weight of the savoury food product,
at least 0.01% and at most 65% of salt (0.01% wt. to 65% wt.);
at least 0.02% and at most 60% of fat (0.02% wt. to 60% wt.);
at least 0.02% and at most 35% (0.02% wt. to 35% wt.) of one or more of starch, starch derivative, maltodextrin and sugar, said composition further comprising;
at least 0.02% and at most 80% (0.02% wt. to 80% wt.) of plant material comprising chlorophyll,
   characterised in that said savoury food product further comprises at least 0.00002% and at most 2% (0.00002% wt. to 2% wt.) of a food grade blue-coloured ingredient.

### DETAILED DESCRIPTION OF THE INVENTION

All amounts in this description are meant to be indicated in % wt. based on the weight of the savoury food product, unless indicated otherwise.

When ranges are indicated with terms “more than” and “at most” it is intended that all ranges subsumed therein may be preferred as well, including the end points of the ranges. Combinations of borders of more and less preferred ranges may be preferred ranges as well and are not excluded from the description.

‘Savoury’ is defined here as having a clear taste but not tasting sweet. Although sugar may be present in a savoury food product, sweet is not the dominating taste and the product is not considered to taste sweet by a consumer. Often a savoury product may taste salty or have an umami taste.

“Food grade” is intended to mean non-toxic for humans and/or suitable for human consumption when applied in the amount indicated here.

In the context of the present invention, preferably, the savoury food product is selected from a bouillon, a soup, a sauce, a seasoning, a bouillon concentrate, a soup concentrate, a sauce concentrate and a herb preparation.

In a preferred aspect, the savoury food product comprises, e.g. as a concentrated product,
at least 3% and at most 65% of salt (3% wt. to 65% wt.);
at least 1% and at most 60% (1% wt. to 60% wt.) of fat;
at least 1% and at most 35% (1% wt. to 35% wt.) of one or more of starch, starch derivative, maltodextrin and sugar, said composition further comprising,
at least 0.2% and at most 20% of plant material comprising chlorofyl,
   characterised in that said concentrate further comprises at least 0.001% and at most 1.5% (0.001% wt. to 1.5% wt.) of a food grade blue-coloured ingredient.

For consumption, such a concentrated product is preferably at least partly dissolved in an aqueous solution, preferably water. Preferably the aqueous solution is warm, preferably boiling, when prepared.

In another preferred aspect, the savoury food product comprises, e.g. as a ready to eat bouillon, soup or sauce,
at least 0.01% wt and at most 3% wt of salt (0.01% wt to 3% wt);
at least 0.02% wt and at most 20% wt of fat (0.02% wt to 20% wt);
at least 0.02% wt and at most 5% wt (0.02 to 5%) of one or more of starch, starch derivative, maltodextrin and sugar, said composition further comprising;
at least 0.02% wt and at most 80% wt of herbs, plant material comprising chlorofyl,
   characterised in that said concentrate further comprises at least 0.00002% wt and at most 2% wt (0.00002% wt. to 2% wt.)of a food grade blue-coloured ingredient.

This bouillon, soup or sauce may be prepared using the concentrated product of the present invention, although this is not required. Especially when very high amounts of plant material comprising chlorophyll are desired, it may be preferred to prepare a ready to eat soup in stead of using a savoury food product according to the invention in concentrated form, as the amount of plant material in concentrates may not reach the desired level then.

It was found that the savoury food product according to the invention may give an improved impression of the plant material comprising chlorophyll, such as e.g. herbs and vegetables, upon prolonged storage (e.g. for at least 3, preferably at least 6 months, and preferably at most 2 years). The plant material comprising chlorophyll may still discolor to yellowish (or later brownish) colour, but the presence of a blue-coloured ingredient can surprisingly counter balance such (to at least some extent), in such a way that to the human naked eye the colour of the plant material comprising chlorophyll still appears as (fresh) green, or at least much greener than would be the case without incorporating said blue-coloured ingredient into the savoury food product. Even more surprising is that such blue colour does not need to be immediately noticeable in the savoury food product prior to usage, as long as an amount of blue coloured ingredient is used which is not too high. The correct amount can easily be determined by the person of average skill in the art by routine experimentation without undue burden: sufficient to counter-balance at least some of the yellowing (and/or browning), but not so much that the savoury food product gets a blue-ish impression.

Yet more surprising is that upon usage of the savoury food product, for example, the bouillon concentrate (e.g. when dissolving the bouillon concentrate in hot water or adding to a dish) the blue coloured ingredient is not present in a visually disturbing way, and in fact is not or hardly noticeable (when present in effective amount, and not in an amount much larger than that, e.g. less than 50% larger than such effective amount).

In the present invention, it is meant that the blue-coloured ingredient is present in the savoury food product, but is not present inside the plant material comprising chlorophyll, but e.g. next it, or possibly adhered to it.

According to the present invention the savoury food product comprises at least 0.00002 and less than 2 wt % of a food grade blue coloured ingredient. Preferably, the blue coloured ingredient is in a solid form. It is preferably present as a powder which is dispersed evenly in (the part of) the savoury food product according to the invention which comprises the chorofyll comprising plant material such as e.g. (green) herbs, vegetables or pieces thereof. The powder preferably is finely divided. Alternatively, food-grade blue coloured material may be dissolved in the savoury food product. This may be the case for example when the savoury food product is in a wet or pasty form.

The preferred amount of blue coloured ingredient in e.g. a ready-to-eat savoury food product such as a bouillon, soup or a sauce may be from at least 0.001 and at most 1% wt (0.001% wt to 1% wt), more preferably from at least 0.1 and at most 0.9% wt, (0.1% wt to 0.9% wt), even more preferably from at least 0.3 wt % and at most 0.6 wt %,(0.3% wt to 0.6% wt). For a concentrated product, the same preferred ranges are suitable, based on the weight of the concentrated savoury food product. For concentrated savoury food products, like e.g. bouillon cubes, the most preferred amount may be 0.1 to 0.3 wt % based on the weight of the concentrate.

Preferably, when preparing the savoury food product according to the invention, said blue-coloured ingredient is present in a solid and finely divided powdery form, when preparing said composition. Then, over time, gradually, part of the compound(s) of said blue-coloured ingredient responsible for the blue colour will dissolve in moisture already present in the savoury food product of the invention, and/or in moisture which is taken up by the savoury food product from the environment. The more moisture is present, the faster such dissolving will be, but also the more moisture, the faster the green colour of the plant material comprising chlorophyll such as e.g. herbs, vegetables or pieces thereof, will turn to yellowish. Surprisingly the speed of fading of the green colour can be counter-balanced by the speed of dissolving of such blue-colour. Without wishing to be bound by theory, it is believed that the blue ingredient is not easily noticeable to the human naked eye when still in a finely divided powdery form, because it is in that form. Once it starts to dissolve in the moisture present, it may be more visible, but then it is counter-balancing the fading green.

For the above mentioned reason, the present invention preferably relates to a savoury food product of the invention wherein the blue-coloured ingredient comprises a blue-coloured ingredient which is soluble in water. Blue-coloured ingredients which are soluble in water may be ingredients derived from Spirulina blue algae. Water-soluble blue-coloured ingredients are in particularly preferred in case when relatively high amounts, e.g. 1-20% wt. based on the weight of the savoury food product, of plant material comprising chlorophyll such as e.g. green or greenish coloured herbs, vegetables or pieces thereof are present in the concentrate and/or when the concentrate has a relatively high amount of fat, such as from e.g. 8% to 60%, such as in e.g. a bouillon cube.

Fat soluble blue-coloured ingredients, such as these that may be derived from e.g. flowers, or mixtures of water- and fat-soluble blue coloured ingredients may preferably be used when relatively low amounts, e.g. 0.1 to 1% wt. of green or greenish coloured herbs, vegetables or pieces thereof are used. A combination of fat-soluble and water-soluble blue-coloured ingredients is further preferred as in this case the counter balancing effect may start in an earlier phase already. This may be the case because the water-soluble blue-coloured material may require an initial solution in water which is derived from the air. Due to the presence of fat-soluble blue-coloured material, the colouring effect can start before water from the air is absorbed by the savoury food product, e.g. the bouillon cube. This in particular advantageous when the savoury food product such as a bouillon cube is intended to be stored in an environment with low relative humidity of the air. Thereto, preferably, in the savoury food product according to the invention the food-grade blue coloured ingredient comprises food-grade blue coloured ingredient which is soluble in fat. In another preferred aspect, in the savoury food product the food-grade blue coloured ingredient comprises food-grade blue coloured ingredient which is soluble in water and food-grade blue coloured ingredient which is soluble in fat. Such a fat-soluble and water-soluble food-grade blue coloured ingredient may preferably be present in a ration of from 10-90 wt % to 90-10%, more preferably from 30-70% to 70-30%, even more preferably, 40-60% to 60-40%, or also in a ration of 50-50%, based on the amount of food-grade blue coloured material. As indicated above, the ration may depend on the e.g. the fat content in the food product or the expected humidity of the storage conditions or of the food product itself.

The food-grade blue coloured material may be of natural or artificial origin. Suitable said blue-coloured vegetable material (vegetables) may e.g. comprise colouring obtained from flowers, preferably blue flowers, or parts thereof (e.g. blue petals). The blue colour may be derived and/or isolated from the organism, including plants, and may show the desired colour first after a treatment, e.g. a pH treatment. The blue coloured ingredient may also be of the origin of an organism other than plants, such as e.g. of an animal or algae, such as e.g. obtained from Spirulina blue-green algae. Especially plant- or algae-derived blue coloured ingredients have the advantage as being perceived as label-friendly and/or all natural. In the present context, algae are considered to be vegetable material. Therefore, preferably, the food grade blue coloured ingredient comprises one or more of blue-coloured vegetable material, a blue dye, a blue coloured coloring agent, and a blue pigment or mixtures thereof. Preferably, the food grade blue-coloured ingredient is a blue-coloured vegetable material comprising material derived from one of the group of flowers, preferably blue flowers, parts thereof and Spirulina blue-green algae and mixtures thereof.

In order to be able to incorporate the blue-coloured vegetable material in said savoury food product according to the present invention, it is preferred that the blue-coloured vegetable material comprises colouring material obtained by a process comprising milling, grinding or comminuting such blue-coloured vegetable material, preferably being flowers or parts thereof, preferably blue flowers, and/or Spirulina blue-green algae. Examples of blue flowers may be one or more of e.g. violet, borage, clover, cornflower, dame's rocket, johnny-jump-up, lavender, pansy or spring gentian. Because of their blue colour, one or more of borage, cornflower or spring gentian is more preferred.

Preferably, in the savoury food product according to the present invention, the blue coloured ingredient in solid, finely divided powdery form has such a particle size that at least 80% by weight of the blue coloured ingredient has a size of below 50 micron, preferably below 5 micron, more preferably at most 1 micron, most preferably at most 0.5 micron, and more than 0.01 micron, preferably more than 0.05 micron, e.g with a particle size of from 0.01 to 5 micron, preferably with a size of 0.05 to 1 micron.

Preferably, the blue coloured ingredient is dispersed evenly in the savoury food product or the part thereof which comprises the plant material comprising chlorophyll.

In a preferred aspect, e.g. when applied in a soup concentrate, the amount of salt is in a range of from at least 3% wt. and at most 13% (3% to 13%), more preferably, in an amount of from at least 6% and at most 10% (6% to 10%). When applied in e.g. a bouillon concentrate, the preferred amount of salt may be from at least 25% and at most 65% (25% to 65%), more preferably from at least 30% and at most 60% (30% to 60%). When applied in e.g. a ready to eat bouillon, soup or sauce, preferably the salt content is at least 0.1% wt and at most 2% wt (0.1 wt %-2% wt), more preferably, at least 0.5 wt % and at most 1 wt % (0.5 wt %-1 wt %). In the present invention salt is intended to mean sodium chloride.

In a preferred aspect, e.g. when applied in a soup concentrate, the amount of fat is in a range of from at least 0.1% and at most 10% (0.1% to 10%), more preferably, in an amount of from at least 0.5% and at most 8% (0.5% to 8%). When applied in e.g. a bouillon concentrate, the preferred amount of fat may be from at least 6% and at most 60% (6% to 60%), more preferably from at least 8% wt. and at most 40% (8% to 40%). The fat content may vary for the different types of savoury food product in ready-to eat form such as e.g. a bouillon, soup or a sauce. A sauce may have a preferred fat content of at least 1 wt % and at most 20% (1% wt. to 20% wt.), more preferably from at least 5 wt % and at most 10 wt % (5% wt. to 10% wt.), based on the weight of the savoury food product. But in case of e.g. a soup the fat content may be lower, such as preferably from at least 0.5 wt % and at most 3 wt % (0.5% wt. to 3% wt.). The fats used are preferably the fats conventionally used in the preparation of the savoury food products according to the invention, and may comprise vegetable fats like e.g. hydrogenated palm oil, hydrogenated rape seed oil, or animal fats like e.g. from beef, pork, lamb, lard or chicken fat. “Fat” preferably is a fat comprising triglycerides. Part of the fat may be oil, which is preferably liquid at room temperature, e.g. for reasons of health or for processing reasons.

According to the invention, the savoury food product comprises plant material comprising chlorophyll. Preferably, the plant material comprising chlorophyll comprises one or more of herbs, vegetables, pieces of herbs, pieces of vegetables and mixture thereof. This plant material may be present in the savoury food product in an equally dispersed form. Alternatively, the plant material may be present as one or a relatively small amount (e.g. form 1 to 20, preferably form 2 to 10) of distinct parts. This may for example be the case when a concentrate dry savoury food product is desired wherein the plant material is e.g. pressed together in one or some compartments, like e.g., tablets, combined with the concentrated savoury food product. Preferably, the plant material comprising chlorofyll, comprises chlorofyll in an amount that the plant material is green when it was fresh. When the savoury product of the present invention is not fresh any more, for example after storage of several weeks or months, the plant material comprising chlorophyll may have turned yellow and lost its green colour. In the present context it should be understood however, that this discoloured plant material should be considered as ‘plant material comprising chlorophyll’, although at least part of the chlorophyll may have discoloured or degraded over time.

The effect of counter-balancing yellowing and browning of plant material comprising chlorophyll with blue coloured ingredient is most noticeable in dry savoury food products such as bouillon-, soup- or sauce concentrates or seasonings, like e.g. conventional bouillon or seasoning cubes or tablets, or such compositions in granular or powdery form. For such savoury food products, the amount of plant material comprising chlorophyll such as e.g. herbs, vegetables or pieces of herbs and/or vegetables is preferably from at least 0.1 and at most 20% (0.1% wt. to 20% wt.), more preferably from at least 0.5 wt % and at most 15 wt % (0.5% wt. to 15% wt.), even more preferably form at least 1 wt % and at most 10 wt % (1% wt. to 10% wt.), most preferably, at least 2 wt % and at most 5 wt % (2% wt. to 5% wt.). The amount may depend on e.g. the type of soup and/or the type of blue coloured ingredient used. In case a savoury food product such as e.g. a bouillon, soup or sauce is a product which is not just prepared from a concentrated savoury food product, but e.g. produced and/or sold as a bouillon, soup or sauce as a wet product, which is preferably ready-to-eat and does not require a dilution step anymore, the maximum amounts of herbs, vegetables or pieces may be higher, i.e. at most e.g. 80% wt., preferably at most 50% wt, more preferably at most 30% wt. (wt % as based on the bouillon, soup or sauce).

In the savoury food product of the invention, the average particle size of the plant material comprising chlorophyll preferably is from 0.04 to 10 mm, more preferably from 0.1 to 5 mm, most preferably from 0.5 to 2 mm.

It is preferred that at least part of the herbs, vegetables or pieces thereof in the savoury food product according to the present invention are green herbs such as e.g. parsley, basil, dill, thyme, rosemary, lovage, coriander, sage, bay, oregano, cress, watercress, chives, and/or green vegetables or pieces thereof such as peas, spinach, broccoli, spring onion, or at least such herbs, vegetables or pieces thereof which are green or greenish in colour when fresh or freshly dried.

Especially in case the savoury food product according to the invention is a dry, e.g. concentrated product such as e.g. a bouillon cube, preferably the present invention relates to a savoury food product which comprises at most 20% of one or more of the group of white, yellow, orange or red herbs, vegetables and pieces thereof, based on the total amount of herbs, vegetables or pieces thereof. The savoury food product according to the present invention preferably comprises at most 20% wt., preferably at most 10% wt., more preferably at most 5% wt, most preferably substantially 0% wt, based on the total amount of herbs, vegetables or pieces thereof of white, yellow, orange or red herbs, vegetables or pieces thereof, such as e.g. cauliflower, carrot, yellow, orange or red (bell) pepper or chili.

Although the lowest concentration is preferred, these ingredients may be present in a range of 0-20 wt %, preferably 0.01-10 wt %, more preferably 1-5%, based on the total amount of herbs, vegetables or pieces thereof. The ratio of chlorophyll comprising material to non-chlorofyl comprising material preferably is higher than 0.5, preferably higher than 1, more preferably higher than 5, most preferably higher than 10.

In a preferred aspect, e.g. when applied in a seasoning, the amount of starch, starch derivate, maltodextrin, or sugar is in a range of from at least 10% and at most 35% (10% to 35%), more preferably in the range of from 15% to at most 20% (15% wt. to 20% wt.). For e.g. ready-to-eat savoury food products such as e.g. a bouillon, a soup or a sauce, the starch content preferably may be higher than 0.5% and may be preferably lower than 3%.

When the savoury food product is a bouillon-, soup- or sauce concentrate, it may further comprise preferably at least one compound selected from the group of monosodium glutamate, spices, starch, sugar, maltodextrin, in a preferred amount of at least 0.5 and at most 20%, preferably at least 2% and at most 10% by weight.

The savoury food product may be a dry product such as e.g. cubes or granules. Cubes may be hard cubes, as prepared by pressing using a machine of e.g. Bonals™ or Bosch™, or may be pasty or soft cubes, as prepared by a machine of Corazza™. Conventionally, savoury food products such as cubes or tablets are perceived by the consumer as dry, but nevertheless usually contain a minor amount of moisture, based on the weight of the savoury food product. Preferably, said savoury food products, like e.g. cubes or tablets, comprises at least 0.3% and at most 8% (0.3% to 8%), preferably from at least 2% and at most 5% (2% to 5%) of moisture. The water activity preferably is from at least 0.2% and at most 0.5% (0.2% to 0.5%) in concentrated savoury food products such as e.g. bouillon cubes.

The savoury food product of the invention is not necessarily a dry product. Also a wet savoury food product such as e.g. a liquid concentrated or ready-to-eat bouillon, soup or sauce are within the scope of the present invention. In this situation the water content may be higher than 8% wt. The water content of wet savoury food products, such as e.g. bouillon, soup or sauce is preferably at least 10 wt % and preferably at most 70 wt % (10 wt % to 70 wt %), more preferably at least 30 wt % and at most 50 wt % (30 wt % to 50 wt %).

The invention further relates to a process for preparing a savoury food product according to the invention, the process comprising the step

a) mixing the ingredients, wt % based on the weight of the savoury food product,
at least 0.01% wt and at most 65% wt of salt (0.01% wt to 65% wt);
at least 0.02% wt and at most 60% wt of fat (0.02% wt to 60% wt);
at least 0.02% wt and at most 35% wt (0.02% wt to 35% wt) of one or more of starch, starch derivative, maltodextrin and sugar;
at least 0.02% wt and at most 80% wt (0.02% wt to 80% wt) of plant material comprising chlorophyll; and
0.00002% wt. and at most 2% wt. (0.00002% wt to 2% wt) of a food grade blue-coloured ingredient.

Optionally, such process is followed by shaping to a granule, agglomerate, briquette, cube or tablet. Preferably, the present invention relates to a process of the invention wherein step

a) involves mixing of:
at least 3% wt and at most 65% wt (3% wt to 65% wt) of salt;
at least 1% wt and at most 60% wt (1% wt to 60% wt) of fat;
at least 1% wt and at most 35% wt (1% wt to 35% wt) of one or more of starch, starch derivative, maltodextrin and sugar;
at least 0.2% wt and at most 20% wt (0.2% wt to 20% wt) of plant material comprising chlorophyll; and
at least 0.001% wt and at most 1.5% wt (0.001% wt to 1.5% wt) of a food grade blue-coloured ingredient, and is followed by the step of

b) shaping the mixture formed in step a) to one of the forms of a granule, an agglomerate, a briquette, a cube or a tablet.

The invention further relates to the use of a savoury food product according to the invention
for preparing one of a bouillon, soup, and sauce, or
as one of a seasoning and food decoration.

In case the savoury food product of the invention is a ready-to-eat product, it may be preferred that it has been prepared by dissolving a concentrated savoury food product according to the invention in e.g. water or in a dish. Clearly, the ingredients as present in the concentrated product become diluted in the resulting read-to-eat savoury food product. For example, when the savoury food product is a concentrate in the form of e.g. a bouillon cube or tablet, the dilution factor may be preferably 10 to 100, preferably from 25 to 70, more preferably from 40 to 60. Hence, in a preferred aspect, the present invention relates to a savoury food product wherein the savoury food product is a ready-to-eat product prepared by, at least partly, dissolving a savoury food product in concentrated form according to the invention in water, a watery solution or a dish.

### EXAMPLE

Bouillon cubes were prepared by mixing standard ingredients as indicated in table 1, base 0. Amounts have been indicated as weight percentages. As green ingredients spinach powder and/or parsley leaves were used, base 1, 2 and 3. A blue colored material powder comprising Spirulina algae was added to base 2 (water soluble), and a blue colored material comprising spring gentian was added to base 3 (fat soluble). Cubes were pressed using a conventional apparatus of Bosch™. Cubes were then stored under ambient conditions protected from light. After three months of storage, the cubes were analysed for the impact of storage conditions on their appearance. The cubes were rated on a scale of 1 (no colour change as compared to the start of the experiment) to 5 (strong colour change, no green colour present), as indicated in Table 2.

TABLE 1

| Raw Materials (wt. % on | | | | |
|---|---|---|---|---|
| bouillon cube) | Base 0 | Base 1 | Base 2 | Base 3 |
| Monosodium glutamate | 13 | 13 | 13 | 13 |
| Salt | 52.8 | 52.8 | 52.8 | 52.8 |
| Fat | 9 | 9 | 9 | 9 |
| Flavour | 0.5 | 0.5 | 0.5 | 0.5 |
| Sugar | 12 | 12 | 12 | 12 |
| Starch | 8.5 | 8.5 | 8.5 | 8.5 |
| Maltodextrin | 4.2 | 0 | 0 | 0 |
| Curcuma | 0 | 0 | 0 | 0.3 |
| Parsiley leaves | 0 | 3.5 | 3.5 | 3.3 |
| Spinach powder | 0 | 0.7 | 0.45 | 0.45 |
| blue material powder | 0 | 0 | 0.25 | 0 |
| (water soluble) | | | | |
| blue material powder | 0 | 0 | 0 | 0.15 |
| (fat soluble) | | | | |
| Total | 100 | 100 | 100 | 100 |

TABLE 2

| Composition | Result |
|---|---|
| Base 0, no green material | Not analysed, reference |
| Base 1, green material, no | Score = 4. Loss of green |
| blue coloured ingredient. | colour. Cube has yellowish |
| | appearance. |
| Base 2, green material, water | Score = 2. Loss of green |
| soluble blue coloured | colour was very minimal, very |
| ingredient. | good appearance. |
| Base 3, green material, fat | Score = 1. No green colour |
| soluble blue coloured | loss. The sample shows |
| ingredient. | similar colour as when the |
| | test started. |

The cubes comprising a blue powder material showed vegetable parts which appeared green, whereas cubes without blue coloured ingredient showed yellow vegetable parts.

Table 3 shows a wet ready to eat soup formulation according to the present invention.

TABLE 3

| Raw materials (wt. % on soup) | control | |
|---|---|---|
| Salt | 0.7 | 0.7 |
| Yeast extract | 0.2 | 0.2 |
| Water | 40.3 | 40.3 |
| Starch | 0.5 | 0.5 |
| green pies | 20 | 20 |
| Zucchini | 10 | 10 |
| other vegetables | 20 | 19.6 |
| vegetable juice | 3.8 | 3.8 |
| Crème fraiche | 4.5 | 4.5 |
| Spices | 0.02 | 0.02 |
| Blue coloured material (spring gentian fine | 0 | 0.4 |
| powder) | | |

1. A savoury food product comprising, all percentages by weight of the savoury food product,
at least 0.01% and at most 65% of salt;
at least 0.02% and at most 60% of fat;
at least 0.02% and at most 35% of one or more of starch, starch derivative, maltodextrin and sugar, said composition further comprising,
at least 0.02% and at most 80% of plant material comprising chlorofyl,
characterised in that said savoury food product further comprises at least 0.00002% and at most 2% of a food grade blue-coloured ingredient.

2. Savoury food product according to claim 1, wherein the savoury food product is selected from a bouillon, a soup, a sauce, a seasoning, a bouillon concentrate, a soup concentrate, a sauce concentrate and a herb preparation.

3. Savoury food product according to claim 1, further comprising at least 0.3% wt. and at most 8% wt. of moisture, based on the weight of the savoury food product.

4. Savoury food product according to claim 1, wherein said food grade blue-coloured ingredient is a blue-coloured vegetable material comprising material derived from one of the group of flowers, preferably blue flowers, parts thereof and Spirulina blue-green algae and mixtures thereof.

5. Savoury food product according to claim 1, wherein at least 80% by weight of the food-grade blue coloured ingredient has a size of below 5 micron, preferably from at least 0.01 and at most 1 micron.

6. Savoury food product according to claim 1, wherein said food-grade blue coloured ingredient comprises food-grade blue coloured ingredient which is soluble in water.

7. Savoury food product according to claim 1, wherein said food-grade blue coloured ingredient comprises food-grade blue coloured ingredient which is soluble in fat.

8. Savoury food product according to claim 1, wherein said food-grade blue coloured ingredient comprises food-grade blue coloured ingredient which is soluble in water and food-grade blue coloured ingredient which is soluble in fat.

9. Savoury food product according to claim 1, wherein the savoury food product comprises at most 20% of one or more of the group of white, yellow, orange or red herbs, vegetables and pieces thereof, based on the total amount of herbs, vegetables or pieces thereof.

10. A process for preparing a savoury food product according to the invention, the process comprising the step of
a) mixing the ingredients, wt% based on the weight of the savoury food product,
at least 0.01% and at most 65% of salt;
at least 0.02% and at most 60% of fat;
at least 0.02% and at most 35% of one or more of starch, starch derivative, maltodextrin and sugar;
at least 0.02% and at most 80% of plant material comprising chlorophyll, and
0.00002% wt. and at most 2% wt. of a food grade blue-coloured ingredient.

11. Process according to claim 10, wherein step a) involves mixing of:
at least 3% and at most 65% of salt;
at least 1% and at most 60% of fat;
at least 1% and at most 35% of one or more of starch, starch derivative, maltodextrin and sugar;
at least 0.2% and at most 20% of plant material comprising chlorophyll; and
at least 0.001% and at most 1.5% of a food grade blue-coloured ingredient, followed by the step of
b) shaping the mixture formed in step a) to one of the forms of a granule, an agglomerate, a briquette, a cube and a tablet.

12. A method of using the savoury food product according to claim 1,
for preparing one of a bouillon, soup, and sauce, or
as one of a seasoning and food decoration.
